(19) United States
(12) Patent Application Publication
(10) Pub. No.: US 2025/0037297 A1
(43) Pub. Date: Jan. 30, 2025

(54) COMBINING DATA CHANNELS TO DETERMINE CAMERA POSE

(71) Applicant: ViFive, Inc., Sunnyvale, CA (US)

(72) Inventors: Inseok Stephen Choi, Louisville, CO (US); Eric Sawyer, Ithaca, NY (US); Soonmin Ko, New York, NY (US)

(21) Appl. No.: 18/779,189

(22) Filed: Jul. 22, 2024

Related U.S. Application Data
(60) Provisional application No. 63/528,556, filed on Jul. 24, 2023.

(51) Int. Cl. G06T 7/70; G06T 7/20; G06T 17/00

(52) U.S. Cl. CPC G06T 7/70; G06T 7/20; G06T 17/00; G06T 2207/20081; G06T 2207/30168; G06T 2207/30196; G06T 2207/30244

(57) ABSTRACT

A system can include a memory and a processing device, operatively coupled to the memory, configured to perform operations including receiving, from a client device using a camera, two-dimensional (2D) image data representing a scene including a subject, providing, to a camera pose identification model, an input including information identifying a set of attributes of the camera, obtaining, from the camera pose identification model, an output including information identifying at least one camera pose parameter, and performing at least one task based on the output. The set of attributes of the camera includes at least one orientation angle of the camera about at least one axis. Performing the at least one task can include generating a three-dimensional (3D) representation of the subject depicted in the 2D image data.

### CROSS-REFERENCE TO RELATED APPLICATION(S)

The present application claims priority to U.S. Provisional Patent Application No. 63/528,556, filed on Jul. 24, 2023, the entire contents of which are hereby incorporated by reference herein.

### TECHNICAL FIELD

The instant specification generally relates to three-dimensional (3D) computer vision. More specifically, the instant specification relates to 3D computer vision techniques that combine data channels to determine camera pose.

### BACKGROUND

Computer vision is a field of artificial intelligence (AI) and/or machine learning (ML) that enables computers to interpret and derive meaningful information from visual inputs such as images and/or videos. Three-dimensional (3D) computer vision is a branch of computer vision that generally relates to analyzing 3D visual data to under the 3D structure of objects and/or scenes by interpreting two-dimensional (2D) video or image sequences. One aspect of 3D computer vision is 3D reconstruction, which involves the process of extracting three-dimensional information and geometric structure from 2D video or image sequences.

Some 3D reconstruction techniques are passive 3D reconstruction techniques, which involve relying on natural light to capture the 3D structure of an object and/or scene without the use of additional energy (e.g., radiation or sound). Passive 3D reconstruction techniques can use image sensors to measure the radiance reflected and/or emitted by the surface of an object. Examples of passive 3D reconstruction techniques include stereo vision (e.g., using multiple cameras to capture multiple images from different viewpoints and inferring depth from the multiple images), structure from motion (SfM) (e.g., using multiple cameras to capture multiple images from different angles inferring structure from motion between the multiple images), shape-from-X (e.g., utilizing image cues such as shading, texture, silhouettes, etc. to reconstruct 3D objects from an image), etc.

Some 3D reconstruction techniques are active 3D reconstruction techniques, which involve directing additional energy toward an object, and measuring the reflected and/or scattered energy from the object to determine depth and/or shape of the object. Examples of active 3D reconstruction techniques include structured light (e.g., projecting a known pattern onto an object and inferring depth by identifying a deformation of the known pattern), time-of-flight (ToF) (e.g., determining distance by measuring the time it takes for emitted light to return after reflecting off of an object), etc. Any suitable type of light can be used. Examples of light include laser, infrared, ultraviolet (UV), visible, etc.

### BRIEF DESCRIPTION OF THE DRAWINGS

The disclosure is illustrated by way of examples, and not by way of limitation, and can be more fully understood with references to the following detailed description when considered in connection with the figures, in which:

FIG. 1 is a diagram of an example computer system that can be used for combining data channels to determine camera pose, in accordance with some embodiments.

FIG. 2 is a diagram illustrating example of a scene, in accordance with some embodiments.

FIG. 3 is a diagram illustrating an example method of performing distortion correction, in accordance with some embodiments.

FIGS. 4-5 are diagrams illustrating an example camera calibration method, in accordance with some embodiments.

FIG. 6 is a diagram illustrating an example system architecture associated with camera pose identification models, in accordance with some embodiments.

FIG. 7 is a diagram illustrating an example training set generator to generate training data for a camera pose identification model, in accordance with some embodiments.

FIG. 8 depicts a flow diagram of an example method for training a camera pose identification model, in accordance with some embodiments.

FIG. 9 depicts a flow diagram of an example method for combining data channels to determine camera pose, in accordance with some embodiments.

FIG. 10 depicts a block diagram of an example computer device within which a set of instructions, for causing the machine to perform any of the one or more methodologies discussed herein can be executed, in accordance with some embodiments.

### DETAILED DESCRIPTION

Embodiments described herein relate to combining data channels to determine camera pose. A camera can be operatively coupled to a client device. For example, a client device can be a desktop, a laptop, a tablet, a mobile device (e.g., a smartphone), etc. A camera can be used to capture images and/or video of a subject within a scene.

3D computer vision techniques can be used to analyze a subject in a scene from image data obtained from a camera (e.g., make measurements of the subject within the scene). However, there may be challenges in analyzing the subject using typical 3D computer vision techniques, particularly when the analysis is based on 2D images (e.g., 2D video). 2D images can inherently distort dimensions of a scene, including the dimensions of the subject, which can create challenges in analyzing the subject.

For example, the camera can be used to capture video of a subject (e.g., a client or a patient) to assist in physical medicine and rehabilitation (e.g., physical therapy). Physical medicine and rehabilitation can include the assessment, diagnosis, and treatment of a wide range of musculoskeletal, neurological, and cardiovascular conditions to help subjects improve their physical function, mobility, and quality of life. Physical medicine and rehabilitation professionals (“professionals”) such as physicians, clinicians, coaches, etc. can design effective solutions to improve subject mobility and/or motor function, which can include the assessment and treatment of a wide range of musculoskeletal and neurological conditions.

A session between a subject and a professional may be conducted either on-premises in a space where both the subject and the professional are located in a single location, or remotely using video conferencing platforms that share video feeds between subject and the professional. For example, an on-premises session can be an on-premises physical therapy (OPT), and a remote session can be a remote physical therapy (RPT) session. In some instances, on-premises sessions can also implement video analysis of the subject, which can include motion tracking and analysis. However, such video analysis is not limited to health and wellness (e.g., physical rehabilitation), but may be applied in remote and on-premises athlete training, dance education, filming, gaming, and virtual reality including metaverse, among other implementations.

A professional can track the movement and/or range of motion of one or more body parts of a subject from a video taken by a camera. As an illustrative example, the professional can track the movement and/or the range of motion of the subject's knee (e.g., knee flexion). By tracking the movement of the one or more body parts of a subject, a professional can assess how well the patient is moving, measure various angles related to the subject's body, and evaluate the movement form. The professional can then provide recommendations to improve the health and fitness of the subject based on the assessment.

Some motion-tracking systems can incorporate auxiliary data obtained from auxiliary devices, such as at least one wearable device worn by the subject (e.g., smartwatches and other smart jewelry, fitness trackers and smart clothing). The auxiliary data can be used to obtain more accurate measurements. Also, some motion-tracking systems can track and reconstruct computer-applicable movement data.

There may be challenges in making accurate physical measurements of a subject using a motion-tracking system, particularly based on 2D images (e.g., video). For example, 2D images can inherently distort scene and/or subject dimensions, including the dimensions of the subject, which can create challenges in obtaining accurate patient measurements using 2D video. In some cases, measurements of a subject obtained from a motion-tracking system may not be clinically useful, such that a professional cannot meaningfully assess, diagnose and/or treat a subject.

Aspects of the disclosure address the above challenges, among others, by using 3D computer vision techniques that combine data channels to determine camera pose. Camera pose can refer to the position and/or orientation of a camera in a 3D space or a scene. In some embodiments, camera pose describes how the camera is placed and angled relative to a coordinate system or a reference object, such as a subject. For example, methods described herein can be implemented by a motion-tracking system. The motion-tracking system can be used for assessment, diagnosis, treatment and progress checking of the movement of a subject over time.

The motion-tracking system can use a camera pose identification model to generate an output including information identifying at least one camera pose parameter of a camera that is capturing 2D image data (e.g., 2D video) of a subject of a scene and/or an estimated value of the at least one camera pose parameter. More specifically, the camera pose identification model can include one or more machine learning models that are trained to determine or infer (e.g., estimate) the at least one camera pose parameter. For example, the output of the camera pose identification model can include the at least one camera pose parameter, an estimated value of the at least one camera pose parameter and/or a level of confidence of that the estimated value of the camera pose parameter reflect the actual geometry, such as 3D geometry of the scene (e.g., reflects the actual position and/or orientation of the camera in space, such as 3D space). Generally, the at least one camera pose parameter can include at least one parameter related to the location and/or orientation of the camera relative to the subject. In some embodiments, the at least one camera pose parameter includes a vertical position of the camera relative to ground (e.g., a height of the camera), an orientation angle of the camera (e.g., relative to the ground or the subject), and/or a distance between the camera and the subject. Further details regarding the output of the camera pose identification model will be described herein.

In some embodiments, the input of the camera pose identification model includes information identifying a set of attributes of the camera. For example, the set of attributes of the camera can include one or more orientation angles of the camera about one or more respective axes. In some embodiments, the set of attributes of the camera are generated based at least in part on sensor data received from at least one sensor operatively coupled to the camera. As another example, the set of attributes of the camera can include camera calibration data. Examples of other types of inputs of the camera pose identification model include information identifying a set of attributes of the subject (e.g., a height of the subject, a body ratio of the subject, 2D and/or 3D keypoints of the subject, shape parameters and/or pose parameters of a 3D model of the subject), information identifying parameters of a 3D model of the subject (e.g., shape and/or pose parameters), information identifying a set of attributes of at least one background object in the scene, information identifying confidence values for one or more types of inputs, etc. Further details regarding inputs to the camera pose identification model will be described herein.

The motion-tracking system can use the information identifying the output of the camera pose identification model (e.g., the at least one camera pose parameter and/or a level of confidence) to perform at least one task. Examples of tasks include generating a 3D representation of the subject depicted in the 2D image data and/or training the camera pose identification model. The 3D representation can be used in various ways, such as by analyzing movement of the subject, which can be used to identify any deviations from a target movement (e.g., a suboptimal movement). The camera pose identification model and/or the 3D representation can also be used as feedback into a keypoint model (e.g. a 2D keypoint model and/or a 3D keypoint model) to improve accuracy of the keypoint model. Further details regarding generating the 3D representation, and performing at least one task based on the output of the camera pose identification model and/or 3D representation will be described herein.

It can be noted that although elements of the disclosure are discussed in terms of sessions related to health and wellness (e.g., physical rehabilitation or therapy), such discussion is for purposes of illustration, rather than limitation. Aspects of the disclosure can be broadly applied to many applications in the field of computer vision (e.g., 3D computer vision) to improve the ability to generate 3D representations of subjects within scenes.

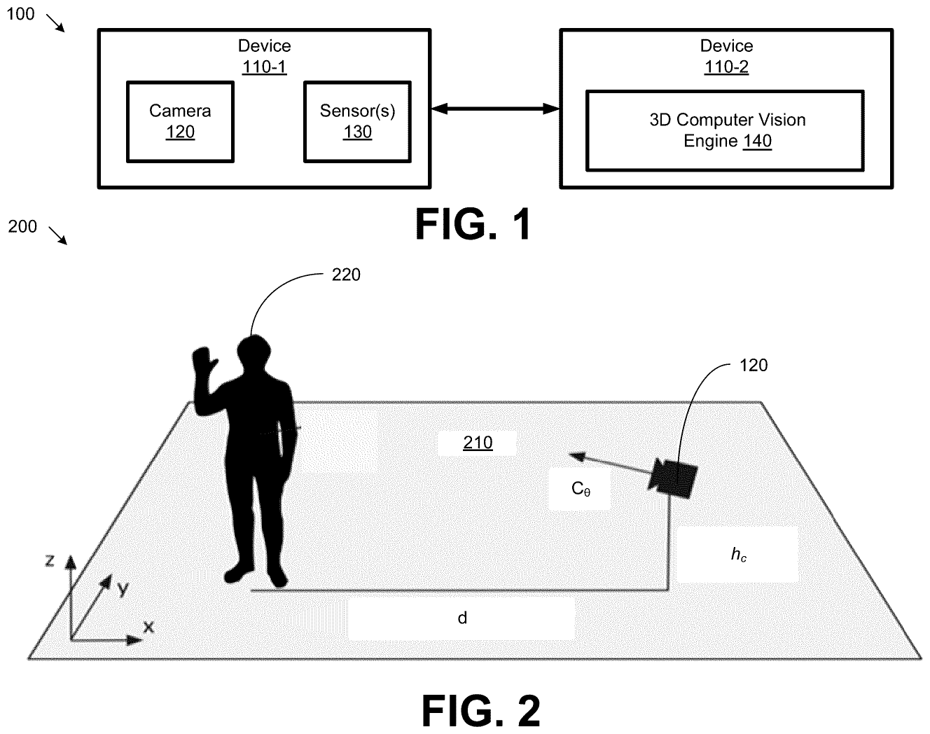

FIG. 1 is a diagram of an example computer system 100, in accordance with some embodiments. As shown, the system 100 can include processing device (“device”) 110-1. For example, the device 110-1 can be a client device operated by a subject (e.g., subject or patient). The device 110-1 can be any suitable device. For example, the device 110-1 can be a desktop, a laptop, a tablet, a mobile device (e.g., a smartphone), etc. The device 110-1 can be operatively coupled to a camera 120 that can capture 2D image data (e.g., still images and/or video). In some embodiments, the camera 120 is integrated within the device 110-1. In some embodiments, the camera 120 is a peripheral device connected to the device 110-1 (e.g., a webcam).

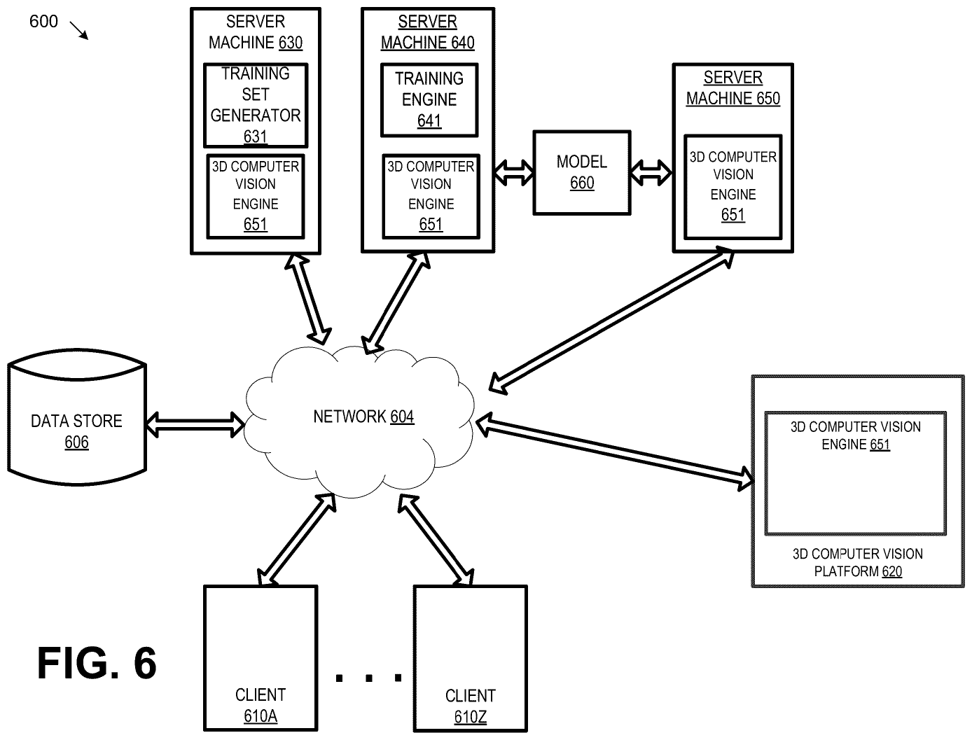

The system 100 can further include processing device (“device”) 110-2. In some embodiments, the device 110-2 operated by another user (e.g., a professional assessing the movement of the subject). For example, the device 110-2 can be a desktop, a laptop, a tablet, a mobile device (e.g., a smartphone), etc. In some embodiments, the device 110-2 is a server, such as a remote server (e.g., cloud server). In some embodiments, device 110-1 and device 110-2 can be connected via a network, such as network 604 described with respect to FIG. 6.

The device 110-2 can implement a 3D computer vision engine (“engine”) 140. For example, the engine 140 can be included in a motion-tracking system. The engine 140 can receive, from the device 110-1 using the camera 120, 2D image data representing a scene including a subject. The engine 140 can include a camera pose identification model that can receive an input.

In some embodiments, the input of the camera pose identification model includes information identifying a set of attributes of the camera 120. The set of attributes of the camera 120 can include at least one orientation angle about at least one axis. More specifically, the set of attributes of the camera 120 can include a first orientation angle of the camera 120 about a first axis, a second orientation angle of the camera 120 about a second axis perpendicular to the first axis, and/or a third orientation angle of the camera 120 about a third axis perpendicular to the first axis and the second axis. For example, the first, second and third orientation angles can correspond to pitch, roll and yaw, without loss of generality.

At one sensor (“sensor(s)”) 130 can be operatively coupled to the camera 120. For example, the sensor(s) 130 can include an internal sensor integrated within the device 110-1 or the camera 120 and/or an external sensor connected to the device 110-1 or the camera 120). For example, the sensor(s) 130 can include one or more Micro-Electro-Mechanical Systems (MEMS) sensors. MEMS sensors are miniature devices that combine mechanical and electronic components to detect and measure physical quantities. Examples of MEMS sensors include accelerometers, gyroscopes (e.g., fiber-optic gyroscopes (FOGs)), magnetometers, pressure sensors, temperature sensors, inertial measurement units (IMUs), microphones, impact sensors, etc. MEMS sensors are typically smaller than traditional sensors. For example, MEMS sensors can have sizes ranging from, e.g., about 20 micrometers to about 1 millimeter, with components of a MEMS sensor having sizes ranging from, e.g., about 1 micrometer to about 100 micrometers. In some embodiments, providing the input to the camera pose identification model further includes receiving sensor data from the sensor(s) 130, and generating at least one attribute of the set of attributes of the camera based at least in part in on the sensor data. The sensor data can include sensor measurements. For example, accelerometer data (e.g., accelerometer measurements) can be used to determine at least one attribute of the set of attributes of the camera (e.g., at least one camera orientation angle).

In some embodiments, the input of the camera pose identification model includes information identifying a set of attributes of the subject. Examples of attributes of the set of attributes of the subject include a height of the subject relative to ground, a body ratio of the subject, at least one keypoint of the subject, etc.

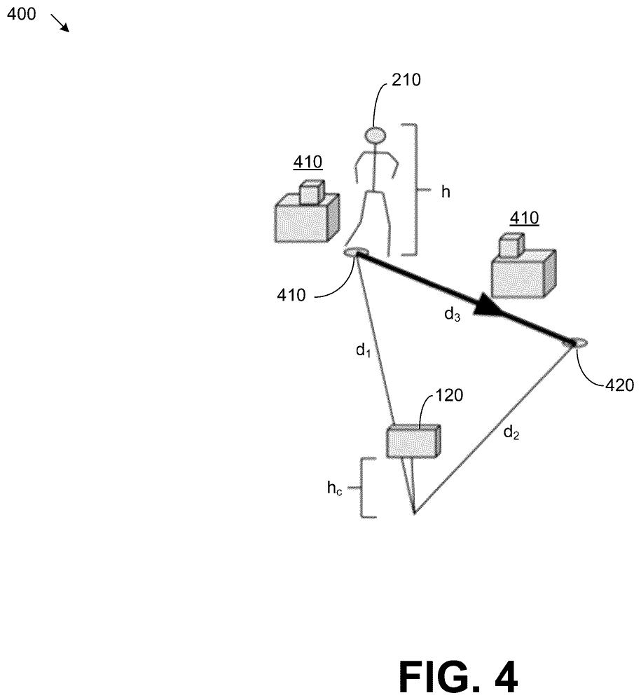

In some embodiments, the body ratio of the subject is a ratio of the length of the upper body to the length of the lower body. For example, the body ratio can be a measured body ratio determined from the raw 2D image data. As another example, the body ratio can be an actual body ratio determined by performing distortion correction of the raw 2D image data. As yet another example, the body ratio can be a body ratio difference determined as the difference between the measured body ratio and the actual body ratio (e.g., absolute value of the difference). Further details regarding the body ratio of the subject will be described below with reference to FIG. 3.

The at least one keypoint can identify at least one specific point of the subject. In some embodiments, the at least one keypoint of the subject includes at least one 2D keypoint. Examples of 2D keypoints include the top of the head, the neck, the nose, the eyes, the ears, the shoulders, the elbows, the wrists, fingertips (e.g., middle finger tip), the center of the spine, the hips, the knees, the ankles, the toes, etc. A 2D keypoint can refer to a specific point (e.g., pixel) in a 2D image. In some embodiments, the 2D keypoint can be characterized by 2D image coordinates (e.g., X-and Y-coordinates) and may have additional attributes such as scale, orientation or descriptor vector. In some embodiments, the 2D keypoint can lack a depth coordinate (e.g., Z-coordinate).

In some embodiments, the at least one keypoint of the subject includes at least one 3D keypoint. A 3D keypoint can be defined by a corresponding 2D keypoint and an additional depth dimension. Keypoints can be determined from one or more 2D images of current 2D image data (e.g., frames of 2D video) and/or one or more historical 2D images of historical 2D image data (e.g., one or more frames of a previous 2D video). A 3D keypoint can refer to a specific point in 3D space. In some embodiments, the 3D keypoint can be characterized by the point's position (X-, Y-, and Z-coordinates) in a 3D coordinate system. In some embodiments, a 3D keypoint can additional attributes such as scale, orientation or descriptor vector.

In some embodiments, the input of the camera pose identification model includes information identifying at least one parameter of a 3D model of the subject. The 3D model can be a statistical model that captures the variability of shapes and/or poses of the human body. For example, the at least one parameter of the 3D model can include at least one shape parameter. A shape parameter is a value that defines the body shape of the subject. There can be multiple shape parameters, where each shape parameter represents a respective aspect of body shape, such as height, weight, body proportions, etc. Various body shapes can be generated by modifying the values of one or more shape parameters (e.g., thin, average, overweight, short, tall). As another example, the at least one parameter of the 3D model can include at least one pose parameter. A pose parameter is a value that defines the pose of the body of the subject. Pose parameters can define the relative rotations of body joints. Various poses can be generated by modifying the values of one or more pose parameters (e.g., standing, sitting, running, jumping). As yet another example, the at least one parameter of the 3D model can include a vector including at least one shape parameter and at least one pose parameter. More specifically, the vector can represent (e.g., encode) the parameters of the 3D model. For example, the vector can be generated by concatenating the at least one shape parameter and the at least one pose parameter. The vector can define a template mesh used to generate the 3D model of the subject. In some embodiments, the 3D model is a skinned multi-person linear model (SMPL).

In some embodiments, the input of the camera pose identification model includes information representing the 2D image data and information identifying at least one 2D keypoint of the 2D image data (e.g., at least one 2D keypoint of the subject).

Some background objects, such as picture frames or other rectangular shapes, can be used to determine information about the camera 120. In some embodiments, the input of the camera pose identification model includes information identifying a set of attributes of at least one background object of the scene. For example, the set of attributes of the at least one background object of the scene can include location information describing at least one location of the at least one background object represented by the 2D image data, and/or at least one measure of distortion of the at least one background object based on a 2D projection of the scene. 2D projection refers to the process of mapping points from 3D space onto respective points of a 2D plane, which can be used to transform the 3D scene into the 2D image data captured by the camera 120. For example, a 2D projection matrix can be used to perform the 2D projection, where the 2D projection matrix includes values defining attributes of the camera 120 (e.g., position, orientation, lens properties). The 2D projection can result in a loss of depth information, which causes objects to appear differently in the 2D image than they appear in the 3D scene. Several factors can cause distortion. For example, distortion can result from the camera 120 using perspective projection, in which the size of objects in a scene decrease in size as a function of distance away from the camera 120. While perspective projection can create a sense of depth, it can also distort the relative size and/or size of objects in the scene. For example, parallel lines in the 3D scene may appear to converge in the 2D image (e.g., rectangular objects in the 3D scene might take on a non-rectangular shape in the 2D image). As another example, distortion can include lens distortion due to the lens of the camera 120. As yet another example, distortion can be caused by the field of view (FOV) of the camera 120 (e.g., wider FOVs can cause greater distortion). Distortion correction can be performed to reduce or eliminate distortion. One example of distortion correction is camera calibration. In some embodiments, the set of attributes of the camera 120 includes camera calibration data for the camera 120. For example, the camera 120 can be calibrated prior to capturing the 2D image data, and the calibrated settings of the camera can be used as input for the camera pose identification model.

In some embodiments, at least one attribute is unknown (e.g., an attribute of the set of attributes of the camera or the subject). In these embodiments, the engine 140 can determine (e.g., estimate) a value of the at least one attribute. For example, if an orientation angle of the camera 120 is not received from the device 110-1 (e.g., from the sensor(s) 130), then the engine 140 can determine orientation angle of the camera 120 using by analyzing the 2D image data. As another example, if the height of the subject is unknown, then the engine 140 can estimate the height of the subject by analyzing the 2D image data.

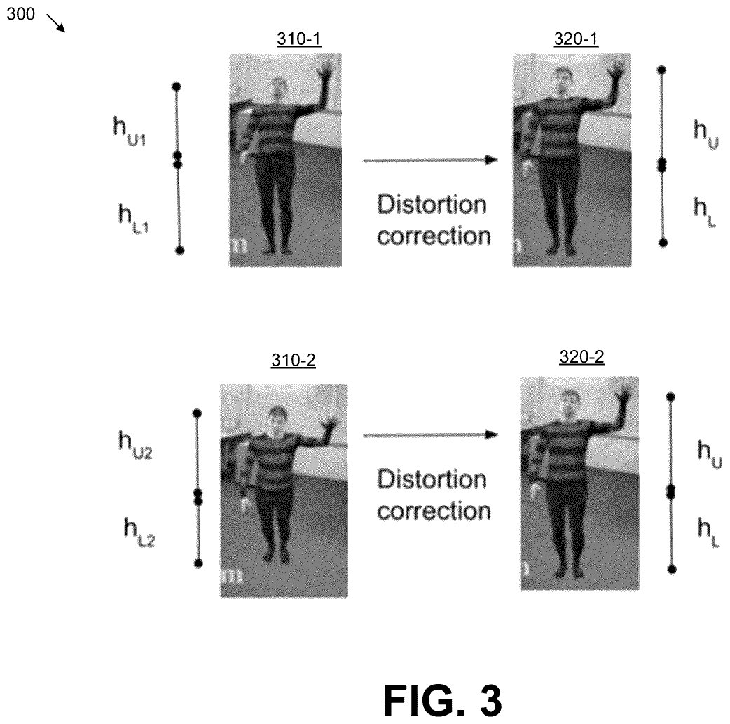

The engine 140 can obtain an output from the camera pose identification model. The output can include information identifying at least one camera pose parameter and/or a level of confidence of the at least one camera pose parameter. The at least one camera pose parameter can include a vertical position of the camera relative to ground, an orientation angle of the camera relative to the subject, and/or or a distance between the camera 120 and the subject. Further details regarding camera pose parameters will be described below with reference to FIG. 2.

The output of the camera pose identification model (e.g., the information identifying at least one camera pose parameter) can be used as an input to perform one or more tasks.

In some embodiments, the output of the camera pose identification model is used to as an input to generate a 3D representation of the subject depicted in the 2D image data. In some embodiments, the engine 140 can analyze at least one movement of the subject by using the 3D representation (e.g., evaluating movement and changes in movement). Analyzing the at least one movement of the subject can include measuring a set of motion parameters associated with the at least one movement of the subject (e.g., speed, distance and/or angle). In some embodiments, analyzing the at least one movement of the subject further includes determining whether the at least one movement of the subject deviates from a target movement, and in response to determining that the at least one movement of the subject deviates from a target movement, providing an indication of the deviation from the target movement, and/or a recommendation to correct the at least one movement. The indication and/or the recommendation can be provided to at least one entity (e.g., the device 110-1 and/or the device 110-2). The analysis can be used to track progress of the subject's mobility over time. In some embodiments, the output of the camera pose identification model and/or the 3D representation is used as feedback into a keypoint model (e.g. a 3D keypoint model) to improve accuracy of the keypoint model.

Generating the 3D representation can include identifying a subject pose (e.g., a 3D subject pose). The output of the camera pose identification model can be used to improve the subject pose identification in various ways. For example, a subject pose identification model can include one or more machine learning models that are trained to generate an output identifying a subject pose of a subject within a scene (e.g., the subject pose and/or a level of confidence of the subject pose). The output of the camera pose identification model can be provided as an input to the subject pose identification model (e.g., to train the subject pose identification model to learn how the camera pose affects the subject pose). Additionally, the output of the camera pose identification model can be used in conjunction with at least one image transformation function to transform an input image for the subject pose identification model. This transformation can be performed to correct for distortions and cause the input image to appear to be approximately from the same height with the subject centered. Thus, this transformation can allow the subject pose identification model to “see” the subject from an approximately consistent view, which can improve subject pose determination accuracy. This can be useful when performing a functional test where 3D angle accuracy may be important regardless of the camera pose.

Additionally or alternatively, the engine 140 can use the output to train the camera pose identification model. The camera pose identification model can be trained to determine the at least one camera pose parameter from an input derived from various combinations of data to address a wide variety of scenarios, including scenarios where at least some types of data are missing for various reasons. In some embodiments, the machine learning model is trained on multiple 2D images of scenes. 2D video inputs may be paired with outputs such as actual measured values of parameters of the 3D geometry of the scene, including measurements of the subjects, and measurements of the background objects. The 2D images can include multiples subjects with different body types, multiple subjects located in different settings with different background objects, and multiple subjects in a variety of physical positions and engaging in different movements. The paired output can also include values for parameters such as camera angle, additional subject data such as size and dimensions of subject bodies, and background object data such as the measurements of the background objects. The training procedure can depend on the type of camera pose identification model, but the inputs, outputs, and training data used by the camera pose identification model can be the same. Examples of types of camera pose identification models include supervised learning models (e.g., regression models and classification models), unsupervised learning models (e.g., clustering models), reinforcement learning models, etc.

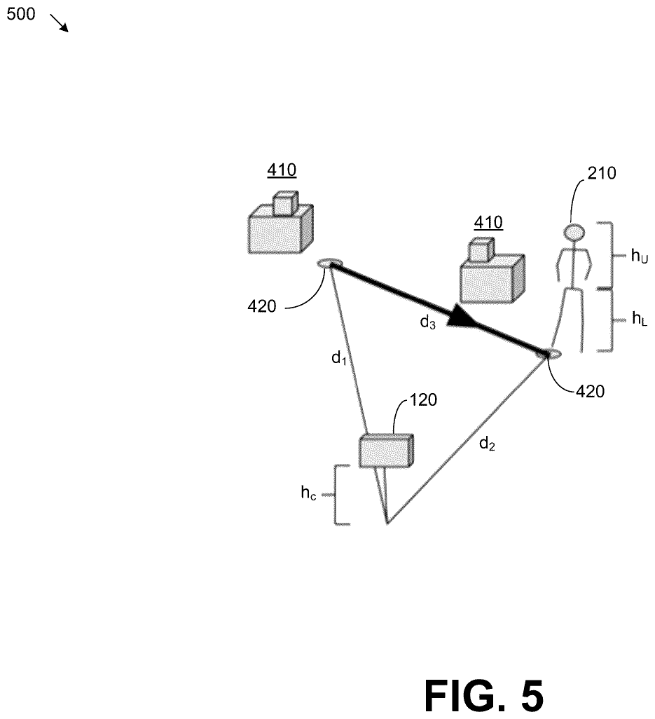

The camera pose identification model can be trained on a number of 2D images and/or 2D videos where the desired outputs have been independently measured. These include examples like a simple walking movement, where the subject begins at one fixed position and walks to another fixed position, and the locations of the two fixed positions and the camera 120 are known in advance. An example of simple walking movement is described below with reference to FIGS. 4-5.

Additionally, the locations and 3D shapes of any background objects observed within the scene may be known in advance. Other training data can include other movements/exercises with known scene geometry, as well as examples of multiple sessions with the same subject. For example, one session can be a calibration session, with the camera at a further distance than would be used for a regular video, which serves to provide an approximately orthographic view of the body of the subject, and sets a baseline for the shape of the body of the subject and body model parameters. In some embodiments, training data can be generated by augmenting input data. For example, training data can be generated by making copies of the dataset and randomly deleting some of the model inputs, which can be used to simulate one or more scenarios where one or more inputs may not be available. Examples of such scenarios include camera orientation angles not being available because the subject is using a built-in laptop camera or webcam to capture video, the upper body keypoints of the subject are not available because the subject is partially out of the view of the camera 120, there are no background objects available that can provide accurate context measurements, etc.

In some embodiments, the background objects are emphasized (e.g., weighted) in the training of the camera pose identification model. The background of a scene is generally fixed and has static background objects (e.g., couches, chairs, tables, window) that persist over multiple sessions. By analyzing changes in angles and distances of the background objects due to different camera orientations (e.g., angles), the ability of the camera pose identification model to generate the output at inference (e.g., at least one camera pose parameter) can be improved.

In some embodiments, the camera pose identification model is calibrated and/or recalibrated (e.g., dynamically recalibrated) using data of a specific subject (e.g., personalized camera pose identification model). For example, at initiation of a session, the subject can be recorded performing a predetermined activity (e.g., walking in a straight line). A 2D video of predetermined activity can be used to calibrate the trained camera pose identification model. In future sessions, historical data can be compared to current session data and used to appropriately calibrate (e.g., re-weight features) of the camera pose identification model.

In some embodiments, the engine 140 uses a combination of multiple input data channels at once (e.g., all input data channels) to make a more robust estimate of the height of the camera 120 and the distance between the camera 120 and the subject. In some embodiments the process is dynamic, taking into account the uncertainties inherent in the data sources. For instance, while the sensor(s) 130 of the device 110-1 can be accurate, the estimates of the device height and distance as produced by the analysis of the body shape may depend on the quality of the key point estimation, and the use of background objects to measure rectangle parallelism can depend on the number and quality of such objects in the background, as well as the quality of the measured fits of lines to the borders of those background objects.

In some embodiments, the ability of the engine 140 to determine the set of parameters in a variety of settings is validated. For example, a validation test can involve the subject walking between fixed points in the view of the camera 120, where the height of the subject and the distances between the points and between the points and the camera 120 are known. The engine 140 can vary this validation test by one or more of placing the camera 120 in different geometries, by using different test subjects, by using a variety of backgrounds, and/or by varying the points from and to which the subject is walking.

The engine 140 can fit the to minimize the errors in testing data, which may fix the model parameters controlling how the different data sources are combined into a single estimate. In some embodiments, combining the inputs to this model includes a linear combination of the parameter estimates from the various sources with fixed (fitted) weights. In some embodiments, the engine 140 can make the weights vary with the confidence levels of the various data sources—for example, the number and fit quality of the background objects determines the confidence of the distance measurement determined by measuring their distortions. In some embodiments, a camera pose identification model used to estimate the parameters of the 3D model of the subject can generate an uncertainty output, which may feed into the weight function for the particular input channel. In some embodiments, the system can produce a reliable result even with only the simplest data input, such as the camera orientation angles along with the subject height or simple body ratio and further achieve additional accuracy when more information is available from the background object and body part measurements.

In some embodiments, the engine 140 utilizes information about the observed body structure of the subject to place constraints on the location of the camera 120 relative to the subject. Extending the idea of using the simple comparison of body ratios described above, the engine 140 can use the parameters (e.g., shape and/or pose parameters) of the 3D model of the subject to make a more robust measurement of how the 2D image is distorted in comparison to a reference measurement. The camera pose identification model can use the 2D image data to estimate values for the parameters of the 3D model of the subject and how the values change through time. During movement, or from one video session to the next, the values of the pose parameters can change, but the values of the shape parameters can remain relatively constant. In some cases, different camera setups can result in different measurements for the shape parameters, which can be compared to a baseline calibration to determine the distortion caused by the camera 120. A calibration measurement can be created first, where the subject places the device as far from themselves as possible (while maintaining a clear image of themselves in the camera), and approximately at hip height. By taking multiple images of the body shape of the subject in this setup, when distortions should be at a minimum, a baseline (e.g., values) for the shape parameters can be obtained. In future video sessions, when the camera placement may be more constrained, the shape parameters can be measured again, and the resulting discrepancies, e.g., of the body part lengths, can be used to reconstruct the vertical distance of the camera 120 relative to the ground and/or the distance between the camera 120 and the user. Since the parameters of the 3D model define the body shape in 3D, each subject body part can produce an estimate for the distance to the camera 120 based on the comparison of that body part shape with the reference calibration measurement. In analogy with a global positioning system (GPS) that can triangulate position of an object with a collection of distance measurements, the engine 140 can triangulate the position of the camera 120 in the scene based on the measurements of the distances from the various body parts.

FIG. 2 is a diagram 200 showing example camera pose parameters of the camera 120, in accordance with some embodiments. For example, the camera pose parameters can include a vertical position of the camera 120 relative to ground 220 (h_{c}), an orientation angle of the camera (C₇₄) and a distance between the camera 120 and a subject 220. When tracking the motion of the subject 210 (e.g., during an exercise such as one performed during a physical therapy session), details of the pose (e.g., position and/orientation) of the camera 120 in the scene can be estimated by the engine 140 in order to properly correct for distortions due to the geometry of the camera 120 and optical properties, and to construct a 3D representation (e.g., 3D model) of the position and/or motion of the subject 210. Distortions can be inherent at least because the camera 120 is viewing the scene from a fixed point, which will generally be somewhat near the subject 210, so that the subject 210 fills most of the FOV of the camera 120. Correcting for distortions based on the position of the camera 120 in the scene can allow for the reconstruction of the 3D position of the subject 210 independent of the pose of the camera 120, which allows for comparison of the form of the movement of the subject 210 (e.g., exercise form) across multiple sessions and in different environments. Correcting for distortions can be challenging in the context of remote sessions, such as RPT, as the subject 210 may need to set up the camera 120 without assistance, may need to place camera 120 at a vertical position lower or higher than ideal vertical position, and may not have adequate space to position the camera 120 in a way that the body of the subject 210 is centered in the FOV. In the context of physical therapy sessions, since small changes in form throughout the course of a treatment plan can be a rich source of information about the effectiveness of the treatment plan, developing an accurate picture of the 3D motion of the subject 210 through time can be valuable.

FIG. 3 is a diagram 300 illustrating an example method of performing distortion correction, in accordance with some embodiments. More specifically, distortion correction can be performed by using body ratios of subjects. For example, the diagram 300 shows original images of a subject 310-1 and 310-2. In the image 310-1, the height of the upper body (e.g., from the torso to the head of the subject) is defined as “h_{U1}” and the height of the lower body (e.g., from the torso to the foot of the subject or ground of the scene) is defined as “h_{L1}”. In the image 310-2, the height of the upper body (e.g., from the torso to the head of the subject) is defined as “h_{U2}” and the height of the lower body (e.g., from the torso to the foot of the subject or ground of the scene) is defined as “h_{L2}”.

In some embodiments, the body ratio of the heights of the subject's lower body to that of their upper body when standing may be known (e.g., from clinical measurements). When the camera is placed closer to the ground, such as that shown in image 310-1, the body ratio will become larger than if the camera were to be placed at hip level, such as that shown in image 310-2.

The diagram 300 further shows distortion corrected images of the subject 320-1 and 320-2 obtained by performing distortion correction on the original images 310-1 and 310-2, respectively. In the images 320-1 and 320-2, the height of the upper body (e.g., from the torso to the head of the subject) is defined as “h_{U}” and the height of the lower body (e.g., from the torso to the foot of the subject or ground of the scene) is defined as “h_{L}”. In the illustrative embodiments of FIG. 3, the following can be assumed: h_{U1}<hᵤ<h_{U2}; h_{L2}<h_{L}<h_{L1}. The body ratio defined by the ratio of h_{U} to h_{L} can be used to estimate the position of the camera (e.g., the height and distance of the camera).

FIGS. 4-5 are diagrams illustrating an example of a camera calibration method, in accordance with some embodiments. More specifically, the method shown in FIGS. 4-5 is a walking test. For example, FIG. 4 is a diagram 400 corresponding to an initial step of the walking test. The diagram 400 shows the camera 120, the subject 210 having height “h”, and background objects 5410 in the scene. The diagram 400 further shows a starting point 410 and an ending point 420. The distance between the starting point 410 and the camera 120 is indicated by “d₁”, the distance between the ending point 420 and the camera 120 is indicated by “d₂” and the starting point 410 is separated from the ending point 420 by a distance “d₃”. The distances d₁ and d₂ may be known ahead of time. As shown in FIG. 4, the subject 210 is initially located at the starting point 410. During the walking test, the subject 210 can be instructed to walk from the starting point 410 to the ending point 420. FIG. 5 is a diagram 500 showing the completion of the walking test in which the subject 210 is now at the ending point 420. For example, the diagram 500 shows the upper body height of the subject (“h_{U}”) and the lower body height of the subject 210 (h_{L}). As the subject 210 approaches the ending point 420, which is closer to the camera 120 in this example, the height of the subject 210 on the screen can increase, the background objects 510 can appear more distorted, and the parameters of the 3D model of the subject 210 (e.g., SMPL model parameters) can become more distorted from the baseline values (measured at a greater distance to the camera 120 than in this test). The body ratio of the upper body height to the lower body height can shrink as the subject 210 approaches the camera 120 if the camera 120 is placed near the floor. The 3D computer vision engine (e.g., the engine 140 of FIG. 1) can minimize the errors in the predicted height and distances in this scenario to calibrate the camera 120.

FIG. 6 is a diagram illustrating an example system 600, in accordance with some embodiments. The system 600 includes an 3D computer vision platform 620, one or more server machines 630 through 650, a data store 606, and client devices 610A-610Z connected to a network 604.

In embodiments, network 604 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Also, during the transmission of session data, security network protocols may include IPSec, virtual private networks (VPNs), SSL, TLS, and/or a combination thereof.

In some embodiments, data store 606 is a volatile or persistent storage that is capable of storing content items such as 2D video, 3D parameters and corresponding values, subject data (e.g., subject or patient data) and background object data as well as data structures to tag, organize, and index the content items. Data store 606 may be hosted by one or more storage devices, such as main memory, magnetic, solid-state or optical storage-based disks, tapes or hard drives, NAS, SAN, and so forth. In some embodiments, data store 606 may be a network-attached file server, while in other embodiments data store 606 may be some other type of persistent storage such as an object-oriented database, a relational database, and so forth, that may be hosted by 3D computer vision platform 620 or one or more different machines coupled to the 3D computer vision platform 620 via the network 604.

The client devices 610A-610Z may each include computing devices such as personal computers (PCs), laptops, mobile phones, smart phones, tablet computers, netbook computers, wearable augmented/virtual/mixed reality headsets, network-connected televisions, etc. In some embodiments, client devices 610A through 610Z may also be referred to as “user devices.”

In some embodiments, the 3D computer vision platform 620 or server machines 630-650 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to content items. For example, the 3D computer vision platform 620 may allow a user to process, modify, consume, upload, and search for 3D computer vision information. The 3D computer vision platform 620 may also include a website (e.g., a webpage) or application back-end software that may be used to provide a user with access to 3D computer vision information or services provided by the 3D computer vision platform 620.

In some embodiments, a “user” may be represented as a single subject. However, other embodiments of the disclosure encompass a “user” being an entity controlled by a set of users and/or an automated source. For example, a set of subject users federated as one or more departments in an organization may be considered a “user.”

In some embodiments, 3D computer vision platform 620 can be a third-party platform. In some embodiments, the third-party 3D computer vision platform 620 is accessible, at least in part, by one or more users of an organization. For example, a third party can provide 3D computer vision services using the 3D computer vision platform 620 to one or more users of an organization. In embodiments, the user may access 3D computer vision platform 620 through a user account. The user may access (e.g., log in to) the user account by providing user account information (e.g., username and password) via an application on client device 610. In some embodiments, 3D computer vision platform 620 can store and host 3D computer vision information and provide access to the 3D computer vision information through client devices 610A-610Z. In some embodiments, 3D computer vision platform 620 includes 3D computer vision engine (“engine”) 651 (e.g., the engine 140 of FIG. 1). In some embodiments, engine 651 can perform 3D computer vision operations, as described herein. In some embodiments, engine 651 hosted by 3D computer vision platform 620 can perform aspects of the disclosure. In some embodiments, engine 651 can be included in any element of FIG. 6, including but not limited to server machine 630, 640, and/or 650.

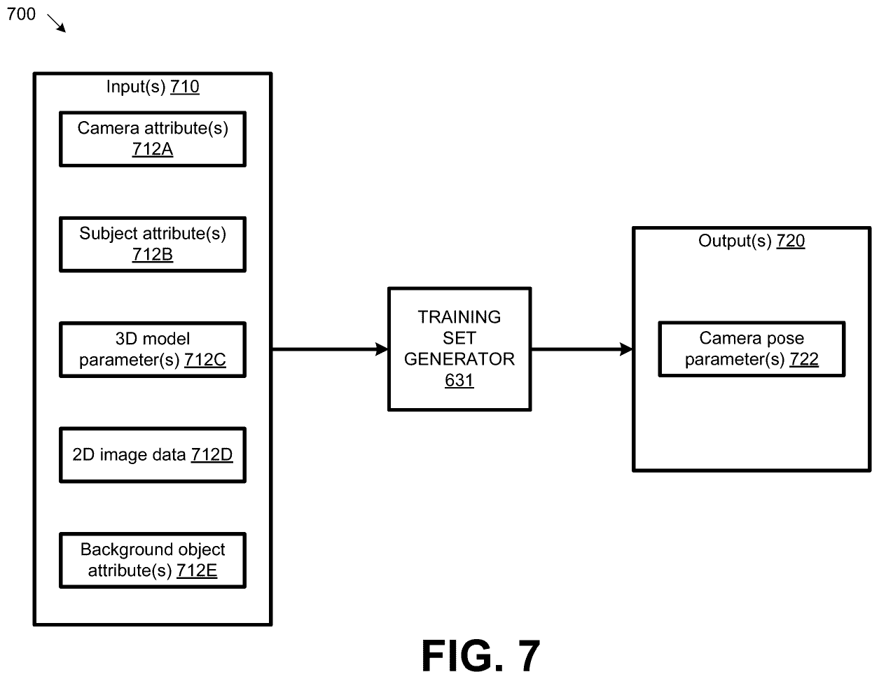

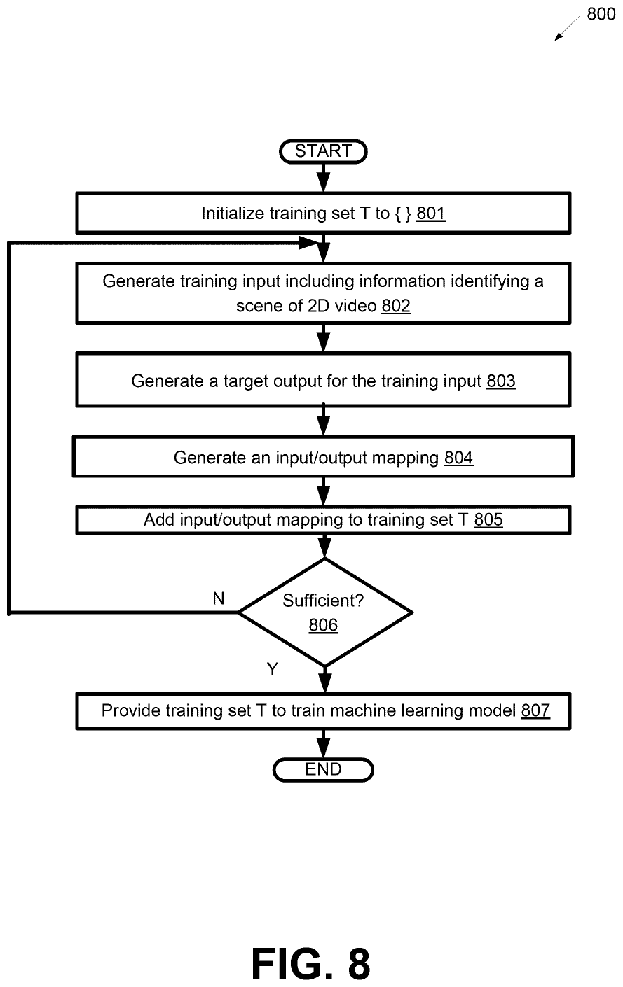

Server machine 630 includes a training set generator 631 that can generate training data (e.g., a set of training inputs and a set of target outputs) to train a camera pose identification model. Some operations of training set generator 631 are described in detail below with respect to FIGS. 7-8.

Server machine 640 includes a training engine 641 that can train at least one at least one machine learning model 660 using the training data from training set generator 631. For example, the at least one at least one machine learning model 660 can include at least one of a camera pose identification model, a subject pose identification model, etc. The at least one machine learning model 660 may refer to the model artifact that is created by the training engine 641 using the training data that includes training inputs and corresponding target outputs (correct answers for respective training inputs). The training engine 641 may find patterns in the training data that map the training input to the target output (the answer to be predicted), and provide the at least one machine learning model 660 that captures these patterns.

In some embodiments, the at least one machine learning model 660 includes at least one neural network. For example, the at least one machine learning model 660 can be trained by adjusting weights of the at least one neural network (e.g., in accordance with a backpropagation learning algorithm or the like). For convenience, the remainder of this disclosure will refer to the implementation as a neural network, even though some implementations might employ other type of learning machine instead of, or in addition to, a neural network. In some embodiments, the at least one machine learning model 660 is a supervised model that uses input-output pairs (e.g., features and labels) as input to train the at least one machine learning model 660.

In some embodiments, the training set is obtained from server machine 630. Server machine 650 can include engine 651 that provides scene data as input to trained at least one machine learning model 660 and runs trained at least one machine learning model 660 on the input to obtain one or more outputs.

In some embodiments, confidence data may include or indicate a level of confidence that one or more values of parameters of 3D geometry of the scene corresponds to the actual scene. In some embodiments, confidence data may include or indicate a level of confidence that one or more estimated values of camera pose parameters reflect the actual 3D geometry of the scene. In one example, the level of confidence is a real number between 0 and 1 inclusive, where 0 indicates no confidence and 1 indicates absolute confidence.

In some embodiments, the output of the at least one machine learning model 660 can identify at least one camera pose parameter and at least one estimated value of the at least one camera pose parameter. In some embodiments, the output of the at least one machine learning model 660 identifies at least one level of confidence that the at least one estimated values of the at least one camera pose parameter accurately reflects the actual geometry of the scene (e.g., camera angle, camera height, subject height). In some embodiments, a determination of whether the level of confidence satisfies a threshold level of confidence can be made. If the level of confidence satisfies a threshold level of confidence, then the system can proceed to perform a task. If the level of confidence does not satisfy the threshold level of confidence, then the system does not proceed to perform the task.

Also as noted above, for purpose of illustration, rather than limitation, aspects of the disclosure describe the training of a camera pose identification model and use of a trained camera pose identification model. In other embodiments, a heuristic model or rule-based model can be used as an alternative. It should be noted that in some other embodiments, one or more of the functions of server machines 630, 640, and 650 or 3D computer vision platform 620 may be provided by a fewer number of machines. For example, in some embodiments server machines 630 and 640 may be integrated into a single machine, while in some other embodiments one or more of server machines 630, 640, 650, or 3D computer vision platform 620 may be integrated into a single machine. In addition, in some embodiments one or more of server machines 630, 640, or 650 may be integrated into the 3D computer vision platform 620.

In general, functions described in one embodiment as being performed by the 3D computer vision platform 620, server machine 630, server machine 640, or server machine 650 can also be performed on the client devices 610A through 610Z in other embodiments, if appropriate. In addition, the functionality attributed to a particular component can be performed by different or multiple components operating together. The 3D computer vision platform 620, server machine 630, server machine 640, or server machine 650 can also be accessed as a service provided to other systems or devices through appropriate application programming interfaces, and thus is not limited to use in websites.

Although embodiments of the disclosure are discussed in terms of 3D computer vision platforms, embodiments may also be generally applied to any type of platform or service.

In situations in which the systems discussed here collect personal information about users, or may make use of personal information, the users may be provided with an opportunity to control whether the 3D computer vision platform 620 collects user information (e.g., information about a user's medical history), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the 3D computer vision platform 620.

FIG. 7 is a diagram 700 of an example training set generator 631, in accordance with some embodiments. System 700 may include similar components as system 700, as described above with respect to FIG. 6. Components described with respect to system 600 of FIG. 6 may be used to help describe system 700 of FIG. 7.

In some embodiments, training set generator 631 generates training data including a training set that includes one or more training inputs (“inputs”) 710, and one or more target outputs (“output(s)”) 720. The training data may also include mapping data that maps the input(s) 710 to the output(s) 720. In some embodiments, the training inputs 710 are paired with the training outputs 720. Training inputs 710 may also be referred to as “features,” “attributes,” or “information.” Output(s) 720 may also be referred to as “labels.” In some embodiments, training set generator 631 provides the training data to a training engine (e.g., the training engine 641 of FIG. 6) used to train at least one machine learning model (e.g., the at least one machine learning model 660 of FIG. 6). For example, the at least one machine learning model can include a camera pose identification model.

In some embodiments, the input(s) 710 include information identifying a set of attributes of a camera 712A (e.g., at least one orientation angle about at least one axis). In some embodiments, the input(s) 710 include information identifying a set of attributes of the subject 712B. Examples of attributes of the set of attributes of the subject include a height of the subject relative to ground, a body ratio of the subject, at least one keypoint of the subject (e.g., at least one 2D keypoint and/or at least one 3D keypoint), etc. In some embodiments, the input(s) 710 include information identifying a set of 3D model parameters of the subject 712C (e.g., at least one shape parameter and/or at least one pose parameter). In some embodiments, the input(s) 710 include information representing the 2D image data 712D. In some embodiments, the input 710 includes information identifying a set of attributes of at least one background object of the scene 712E. In some embodiments, any of the inputs 710 can include confidence values corresponding to particular inputs. In some embodiments, the confidence values reflect a confidence (e.g., probability) that a particular input reflects the actual object, measurement, parameter, etc. In some embodiments, the confidence value can reflect a tolerance of an input (e.g., that a measurement is within a particular tolerance). Further details regarding the input(s) 710 are described above with reference to FIGS. 1-6.

In some embodiments, the output(s) 720 include at least one camera pose parameter 722A. Further details regarding the output(s) 720 are described above with reference to FIGS. 1-6.

In some embodiments, subsequent to generating a training set and training at least one machine learning model 660 using the training set, the at least one machine learning model 660 is trained (e.g., additional data for a training set) or adjusted (e.g., adjusting weights associated with input data of the at least one machine learning model 660, such as connection weights in a neural network) using additional training inputs and target outputs.

FIG. 8 depicts a flow diagram of one example method 800 for training a camera pose identification model, in accordance with some embodiments. For example, the camera pose identification model (e.g., the model 660 of FIG. 6) can be trained to determine at least one camera pose parameter.

At block 801, processing logic initializes a training set T to an empty set.

At block 802, processing logic generates a training input. For example, the training input can include data associated with a scene within 2D image data captured by a camera. Examples of training data can include one or more of a set of attributes of the camera, a set of attributes of a subject, at least one parameter of a 3D model of the subject, a set of attributes of at least one background object, and/or data confidence measurements. More specifically, the training data can include any suitable combination of these examples.

At block 803, processing logic generates a target output for the training input. In some embodiments, the target output includes at least one camera pose parameter.

At block 804, processing logic (optionally) generates an input/output mapping. The input/output mapping (or mapping data) may refer to the training input (e.g., one or more of the training inputs described herein), the set of target outputs for the training input (e.g., one or more of the target outputs described herein), and an association between the training input(s) and the target output(s). In some embodiment, the first training input is mapped to the first target output. At block 805, processing logic adds the mapping data optionally generated at block 804 to the training set T.

At block 806, processing logic determines whether training set T is sufficient for training the camera pose identification model. If so, execution proceeds to block 807, otherwise, execution reverts back to block 802. In some embodiments, the sufficiency of training set T may be determined based on the number of input/output mappings in the training set. In other embodiments, the sufficiency of training set T may be determined based on one or more other criteria (e.g., a measure of diversity of the training examples, accuracy exceeding a threshold, etc.) in addition to, or instead of, the number of input/output mappings.

At block 807, processing logic provides training set T to train the camera pose identification model. In some embodiments, the training set T is provided to a training engine (e.g., the training engine 641 of FIG. 6) to perform the training. In the case of a neural network, for example, input values of a given input/output mapping (e.g., numerical values associated with input 710 of FIG. 7) are input to the neural network, and output values (e.g., numerical values associated with target output 720 of FIG. 7) of the input/output mapping are stored in the output nodes of the neural network. The connection weights in the neural network are then adjusted in accordance with a learning algorithm (e.g., back propagation, etc.), and the procedure is repeated for the other input/output mappings in training set T. After block 807, the camera pose identification model can be trained using the training engine. The trained camera pose identification model may be implemented by a 3D computer vision engine (e.g., the engine 140 of FIG. 1 and/or the engine 651 of FIG. 6). In some embodiments, the camera pose identification model is a supervised camera pose identification model. In some embodiments, the one or more training inputs are paired with the set of target outputs to train the camera pose identification model.

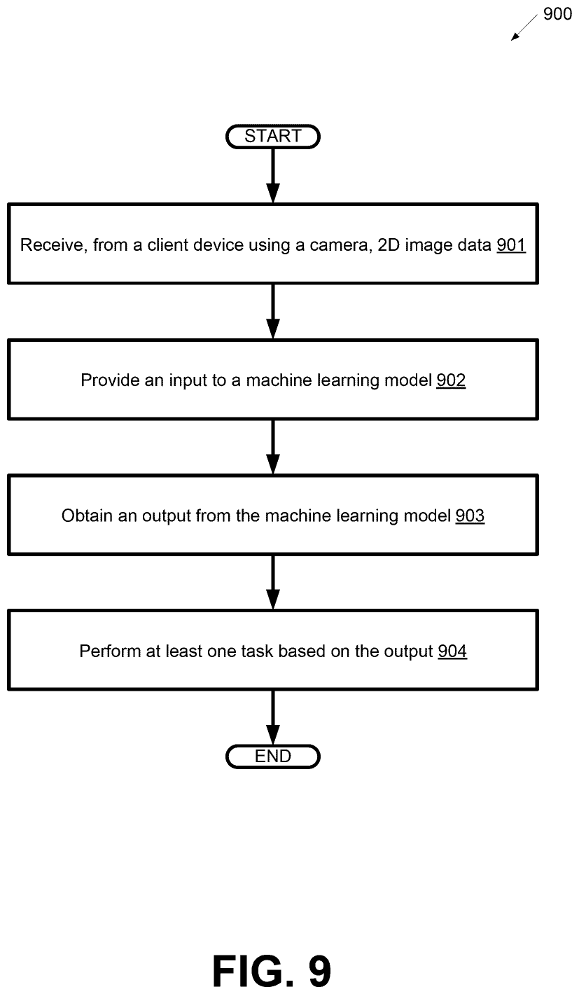

FIG. 9 depicts a flow diagram of an example method 900 for combining data channels to determine camera pose, in accordance with some embodiments. At block 901, processing logic receives, from a client device using a camera, 2D image data. In some embodiments, the camera is a standalone device (e.g., a peripheral device connected to the client device). The 2D image data can represent a scene including a subject. In some embodiments, the camera is integrated within the client device. In some embodiments, the scene includes at least one background object (e.g., an object that is not the subject).

At block 902, processing logic provides an input to a camera pose identification model. The input can include information identifying a set of attributes of the camera. In some embodiments, the set of attributes of the camera includes at least one of: a first orientation angle of the camera about a first axis, a second orientation angle of the camera about a second axis perpendicular to the first axis, or a third orientation angle of the camera about a third axis perpendicular to the first axis and the second axis. For example, the first axis can be the x-axis, the second axis can be the y-axis and the third axis can be the z-axis in a Cartesian coordinate system, and the first, second and third orientation angles can correspond to pitch, roll and yaw. In some embodiments, providing the input to the camera pose identification model further includes receiving sensor data from at least one sensor operatively coupled to the camera, and generating at least one attribute of the set of attributes of the camera based at least in part on the sensor data. In some embodiments, the set of attributes of the camera further includes camera calibration data.

In some embodiments, the input includes information identifying a set of attributes of the subject. For example, the set of attributes of the subject can include at least one of: a height of the subject relative to ground, a body ratio of the subject, or a keypoint of the subject. A keypoint of the subject can be a 2D keypoint or a 3D keypoint (e.g., a 2D keypoint and an additional depth dimension). In some embodiments, the input includes information representing the 2D image data and information identifying at least one 2D keypoint of the 2D image data. The at least one 2D keypoint of the 2D image data can identify at least one specific point of the subject.

In some embodiments, the input includes information identifying a shape parameter of a 3D model of the subject, a pose parameter of the 3D model of the subject, or a vector comprising the shape parameter and the pose parameter. For example, the 3D model of the subject can be an SMPL model of the subject.

In some embodiments, the input includes information identifying a set of attributes of at least one background object in the scene. For example, the set of attributes of the at least one background object in the scene can include at least one of: location information describing at least one location of the at least one background object represented by the 2D image data, or at least one measure of distortion of the at least one background object based on a 2D projection of the scene.

In some embodiments, at least one attribute is unknown (e.g., an attribute of the set of attributes of the camera or the subject). In these embodiments, processing logic can determine (e.g., estimate) a value of the at least one attribute. For example, if an orientation angle of the camera is not received from the client device (e.g., sensor data), then processing logic can determine the orientation angle of the camera using by analyzing the 2D image data. As another example, if the height of the subject is unknown, then processing logic can estimate the height of the subject by analyzing the 2D image data.

At block 903, processing logic obtains an output from the camera pose identification model. The output can include information identifying at least one camera pose parameter. The at least one camera pose parameter can define an orientation and/or position of the camera within the scene. For example, the at least one camera pose parameter can include at least one of: a vertical position of the camera relative to ground, an orientation angle of the camera, or a distance between the camera and the subject. In some embodiments, the output further includes information identify a level of confidence that the at least one camera pose parameter matches the input.

At block 904, processing logic performs at least one task based on the output. In some embodiments, performing the at least one task based on the output includes at least one of: generating a 3D representation of the subject depicted in the 2D image data, or training the camera pose identification model. In some embodiments, generating the 3D representation includes identifying a subject pose (e.g., a 3D subject pose).

In some embodiments, performing the at least one task based on the output includes determining whether the level of confidence that the at least one camera pose parameter matches the input satisfies a threshold level of confidence, and causing the 3D representation of the subject depicted in the 2D image data to be generated in response to determining that the level of confidence that the at least one camera pose parameter matches the input satisfies the threshold level of confidence. In response to determining that the level of confidence that the at least one camera pose parameter matches the input does not satisfy the threshold level of confidence, then performing the at least one task can further include training (e.g., retraining) the camera pose identification model.

In some embodiments, performing the at least one task based on the output further includes analyzing at least one movement of the subject by using the 3D representation (e.g., evaluating movement and/or changes in movement). For example, analyzing the at least one movement of the subject comprises measuring a set of motion parameters associated with the at least one movement of the subject (e.g., speed, distance and/or angle).

In some embodiments, analyzing the at least one movement of the subject further includes determining whether the at least one movement of the subject deviates from a target movement and, in response to determining that the at least one movement of the subject deviates from a target movement, providing, to at least one entity, at least one of: an indication of the deviation from the target movement, or a recommendation to correct the at least one movement. The target movement can be a movement of at least one body part of the subject that is considered optimal or near-optimal. Illustratively, a movement of the subject is a squat, and the subject's squat motion can be tracked and analyzed to determine whether the squat is being performed suboptimally (e.g., can lead to injury or imbalance). More specifically, the indication and/or the recommendation can be provided to at least one client device associated with the at least one entity. For example, the at least one entity can include the subject (e.g., subject or patient). Additionally or alternatively, the at least one entity can include at least one non-subject individual (e.g., at least one professional such as a physical therapist or other healthcare provider).

The camera pose identification model can be trained to determine the at least one camera pose parameter from an input derived from various combinations of data to address a wide variety of scenarios, including scenarios where at least some types of data are missing for various reasons. In some embodiments, the machine learning model is trained on multiple 2D images of scenes. 2D video inputs may be paired with outputs such as actual measured values of parameters of the 3D geometry of the scene, including measurements of the subjects, and measurements of the background objects. The 2D images can include multiples subjects with different body types, multiple subjects located in different settings with different background objects, and multiple subjects in a variety of physical positions and engaging in different movements. The paired output can also include values for parameters such as camera angle, additional subject data such as size and dimensions of subject bodies, and background object data such as the measurements of the background objects. The training procedure can depend on the type of camera pose identification model, but the inputs, outputs, and training data used by the camera pose identification model can be the same. Examples of types of camera pose identification models include supervised learning models (e.g., regression models and classification models), unsupervised learning models (e.g., clustering models), reinforcement learning models, etc.

In some embodiments, the camera pose identification model and/or the 3D representation is used as feedback into a keypoint model (e.g. a 2D keypoint model and/or a 3D keypoint model) to improve accuracy of the keypoint model.

The methods described herein (e.g., the method 800 of FIG. 8 and/or the method 900 of FIG. 9) can be performed by processing logic that may include hardware (circuitry, dedicated logic, etc.), software (e.g., instructions run on a processing device), or a combination thereof. The methods as described herein and/or each of the aforementioned methods' subject functions, routines, subroutines, or operations can be performed by at least one processing device, having one or more processing units (CPU, GPU, neural processing unit (NPU), deep learning processor (DLP), or AI accelerator) and memory devices communicatively coupled to the at least one processing device. In some embodiments, the aforementioned methods can be performed by a single processing thread or alternatively by two or more processing threads, each thread executing one or more subject functions, routines, subroutines, or operations of the method. The aforementioned methods as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, methods 800 and/or 900 can be performed by the engine 140 of FIG. 1, the engine 651 of FIG. 6, and/or the training set generator 631 of FIGS. 6-7. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed.

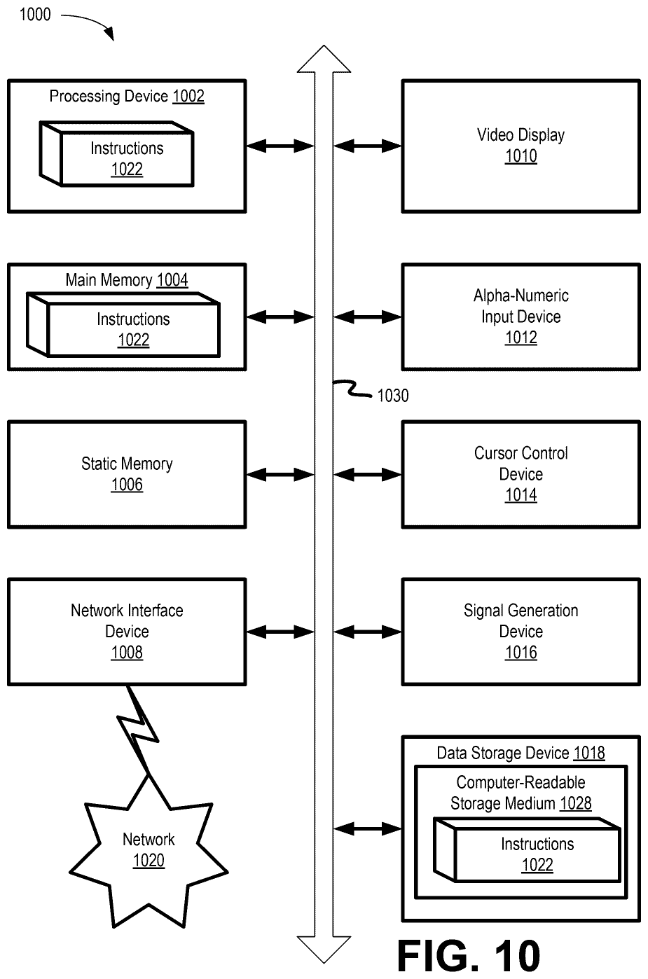

FIG. 10 depicts a block diagram of an example computer device 1000 within which a set of instructions, for causing the machine to perform any of the one or more methodologies discussed herein can be executed, in accordance with some embodiments. Example computer device 1200 can be connected to other computer devices in a LAN, an intranet, an extranet, and/or the Internet. Computer device 1000 can operate in the capacity of a server in a subject-server network environment. Computer device 1000 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” includes any collection of computers that subjectly or jointly execute a set (or multiple sets) of instructions to perform any one or more of the methods discussed herein. In some embodiments, the computer device 1000 is the device 110-1 and/or the device 110-2 of FIG. 1.

Example computer device 1000 can include a processing device 1002 (also referred to as a processor or CPU), which can include instructions 1022, a main memory 1004 (e.g., read-only memory (ROM), flash memory, dynamic random access memory (DRAM) such as synchronous DRAM (SDRAM), high bandwidth memory (HBM) etc.), a static memory 1006 (e.g., flash memory, static random access memory (SRAM), etc.), and a secondary memory (e.g., a data storage device 1018), which can communicate with each other via a bus 1030.

Processing device 1002 represents one or more general-purpose processing devices such as a microprocessor, central processing unit, graphics processing units (GPUs), general purpose GPUs (GPGPUs), neural processing units (NPUs), data processing units (DPUs), deep learning processors, artificial intelligence (AI) accelerators, or the like. More particularly, processing device 1002 can be a complex instruction set computing (CISC) microprocessor, reduced instruction set computing (RISC) microprocessor, very long instruction word (VLIW) microprocessor, scalar execution processor, processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like.

Example computer device 1000 can further comprise a network interface device 1008, which can be communicatively coupled to a network 1020. Example computer device 1000 can further comprise a video display 1010 (e.g., a liquid crystal display (LCD), organic light-emitting diode, a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 can include a computer-readable storage medium (or, more specifically, a non-transitory computer-readable storage medium) 1028 on which is stored one or more sets of executable instructions 1022.

Executable instructions 1022 can also reside, completely or at least partially, within main memory 1004 and/or within processing device 1002 during execution thereof by example computer device 1000, main memory 1004 and processing device 1002 also constituting computer-readable storage media. Executable instructions 1022 can further be transmitted or received over a network via network interface device 1008. Executable instructions 1022 can include one or more of the engine 140, the engine 651, the training set generator 631, or the training engine 641.

While the computer-readable storage medium 1028 is shown in FIG. 10 as a single medium, the term “computer-readable storage medium” should be taken to include a single medium or multiple media (e.g., a centralized or distributed database, and/or associated caches and servers) that store the one or more sets of VM operating instructions. The term “computer-readable storage medium” includes any medium that is capable of storing or encoding a set of instructions for execution by the machine that cause the machine to perform any one or more of the methods described herein. The term “computer-readable storage medium” includes, but is not limited to, solid-state memories, and optical and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, solid state drives (SSDs), magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the disclosure is not described with reference to any particular programming language. It will be appreciated that a variety of programming languages can be used to implement the teachings of the disclosure as described herein.

The disclosure can be provided as a computer program product, or software, that can include a machine-readable medium having stored thereon instructions, which can be used to program a computer system (or other electronic devices) to perform a process according to the disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an embodiment,” “one embodiment,” “some embodiments,” “an implementation,” “one implementation,” “some implementations,” or the like throughout may or may not mean the same embodiment or implementation. One or more embodiments or implementations described herein may be combined in a particular embodiment or implementation. The terms “first,” “second,” “third,” “fourth,” etc. as used herein are meant as labels to distinguish among different elements and may not necessarily have an ordinal meaning according to their numerical designation.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory; and
at least one processing device, operatively coupled to the memory, configured to perform operations comprising:
receiving, from a client device using a camera, two-dimensional (2D) image data representing a scene including a subject;
providing, to a camera pose identification model, an input comprising information identifying a set of attributes of the camera, wherein the set of attributes of the camera comprises at least one orientation angle of the camera about at least one axis;
obtaining, from the camera pose identification model, an output comprising information identifying at least one camera pose parameter and an estimated value of the at least one camera pose parameter; and
performing at least one task based on the output, wherein performing the at least one task comprises generating a three-dimensional (3D) representation of the subject depicted in the 2D image data.

2. The system of claim 1, wherein providing the input to the camera pose identification model further comprises:
receiving sensor data from at least one sensor operatively coupled to the camera; and
generating at least one attribute of the set of attributes of the camera based at least in part on the sensor data.

3. The system of claim 1, wherein the input further comprises information representing the 2D image data and information identifying at least one 2D keypoint of the 2D image data, and wherein the at least one 2D keypoint identifies at least one specific point of the subject.

4. The system of claim 1, wherein the input to the camera pose identification model further comprises information identifying a set of attributes of the subject, and wherein the set of attributes of the subject comprises at least one of: a height of the subject relative to ground, a body ratio of the subject, a 2D keypoint of the subject, or a 3D keypoint of the subject.

5. The system of claim 1, wherein the input further comprises information identifying at least one of: a shape parameter of a 3D model of the subject, a pose parameter of the 3D model of the subject, or a vector comprising the shape parameter and the pose parameter.

6. The system of claim 1, wherein the input further comprises information identifying a set of attributes of at least one background object in the scene, and wherein the set of attributes of the at least one background object in the scene comprises at least one of: location information describing at least one location of the at least one background object represented by the 2D image data, or at least one measure of distortion of the at least one background object based on a 2D projection of the scene.

7. The system of claim 1, wherein the set of attributes of the camera comprises camera calibration data.

8. The system of claim 1, wherein the at least one camera pose parameter comprises at least one of: a vertical position of the camera relative to ground, an orientation angle of the camera, or a distance between the camera and the subject.

9. The system of claim 1, wherein the operations further comprise analyzing at least one movement of the subject by using the 3D representation, and wherein analyzing the at least one movement of the subject comprises measuring a set of motion parameters associated with the at least one movement of the subject.

10. The system of claim 9, wherein analyzing the at least one movement of the subject further comprises:
determining whether the at least one movement of the subject deviates from a target movement; and
in response to determining that the at least one movement of the subject deviates from a target movement, providing, to at least one entity, at least one of: an indication of the deviation from the target movement, or a recommendation to correct the at least one movement.

11. A method, comprising:
receiving, from a client device using a camera, two-dimensional (2D) image data representing a scene including a subject;
providing, to a camera pose identification model, an input comprising information identifying a set of attributes of the camera, wherein the set of attributes of the camera comprises at least one orientation angle of the camera about at least one axis;
obtaining, from the camera pose identification model, an output comprising information identifying at least one camera pose parameter; and
performing at least one task based on the output, wherein performing the at least one task comprises generating a three-dimensional (3D) representation of the subject depicted in the 2D image data.

12. The method of claim 11, wherein providing the input to the camera pose identification model further comprises:
receiving sensor data from at least one sensor operatively coupled to the camera; and
generating at least one attribute of the set of attributes of the camera based at least in part on the sensor data.

13. The method of claim 11, wherein the input further comprises information representing the 2D image data and information identifying at least one 2D keypoint of the 2D image data, and wherein the at least one 2D keypoint identifies at least one specific point of the subject.

14. The method of claim 11, wherein the input further comprises information identifying a set of attributes of the subject, and wherein the set of attributes of the subject comprises at least one of: a height of the subject relative to ground, a body ratio of the subject, a 2D keypoint of the subject, or a 3D keypoint of the subject.

15. The method of claim 11, wherein the input further comprises information identifying at least one of: a shape parameter of a 3D model of the subject, a pose parameter of the 3D model of the subject, or a vector comprising the shape parameter and the pose parameter.

16. The method of claim 11, wherein the input further comprises information identifying a set of attributes of at least one background object in the scene, and wherein the set of attributes of the at least one background object in the scene comprises at least one of: location information describing at least one location of the at least one background object represented by the 2D image data, or at least one measure of distortion of the at least one background object based on a 2D projection of the scene.

17. The method of claim 11, wherein the set of attributes of the camera comprises camera calibration data.

18. The method of claim 11, wherein the at least one camera pose parameter comprises at least one of: a vertical position of the camera relative to ground, an orientation angle of the camera, or a distance between the camera and the subject.

19. The method of claim 18, further comprising analyzing at least one movement of the subject by using the 3D representation, wherein analyzing the at least one movement of the subject comprises measuring a set of motion parameters associated with the at least one movement of the subject.

20. The method of claim 19, wherein analyzing the at least one movement of the subject further comprises:
determining whether the at least one movement of the subject deviates from a target movement; and
in response to determining that the at least one movement of the subject deviates from a target movement, providing, to at least one entity, at least one of: an indication of the deviation from the target movement, or a recommendation to correct the at least one movement.
